(19) United States
(12) Patent Application Publication
(10) Pub. No.: US 2013/0196282 A1
(43) Pub. Date: Aug. 1, 2013

(54) METAL MESH ON CERAMIC BRACKET; CERAMIC BRACKET WITH METAL INSERT; METAL BRACKET WITH TOOTH-COLORED COATING; SELF-LEGATING, LOW PROFILE, METAL BRACKET; AND METHODS OF MAKING SAME

(71) Applicants: John E. Eichelberger, Aliso Viego, CA (US); Hyop Seung Rhee, Saratoga, CA (US); Chris Gipe, San Juan Capistrano, CA (US)

(72) Inventors: John E. Eichelberger, Aliso Viego, CA (US); Hyop Seung Rhee, Saratoga, CA (US); Chris Gipe, San Juan Capistrano, CA (US)

(21) Appl. No.: 13/496,350

(22) PCT Filed: Sep. 15, 2009
(86) PCT No.: PCT/US09/56969

§ 371 Date: Nov. 5, 2012

(51) Int. Cl. A61C 7/30

(52) U.S. Cl. CPC A61C 7/30
USPC 433/9; 433/24; 433/8; 433/11

(57) ABSTRACT

An orthodontic bracket includes a bracket portion including a receiving slot extending across at least a portion of the bracket portion and configured to receive an arch wire. The bracket includes a metal mesh bonded to the ceramic bracket portion on a side of the ceramic bracket portion opposite the receiving slot. Another orthodontic bracket includes a metal core coated with a tooth-colored coating. Methods of attaching and aligning the brackets are provided as well as a tool for aligning the brackets. Inserts are also described for reinforcing the brackets and/or increasing a surface area for enhancing bonding strength.

### BACKGROUND OF THE INVENTION

1. Field of the Invention

This invention relates to a bracket configured to support arch wires used in braces for teeth. Another example of the invention relates to a ceramic bracket for braces for teeth, wherein the ceramic bracket includes a metal insert. Another example of the invention includes a metal bracket for braces installed on a patient's teeth, wherein the metal bracket includes a tooth-colored coating. Another example of the invention relates to a self-legating, low-profile, metal bracket used to support arch wires for braces installed on patient's teeth.

2. Description of the Related Art

Orthodontic therapy relates to the treatment of improperly aligned teeth via mechanical straightening of the teeth over time. Typically, orthodontic treatment involves use of a mouth-piece or use of “braces” to apply pressure to teeth over a long period of time to gradually force the teeth into alignment.

Treatment with braces typically involves attaching small, slotted, metal or ceramic appliances known as brackets to a patient's teeth. An arch wire is typically connected to the brackets and applies tension and/or torque to the crooked teeth based on tension set by an orthodontist when the braces are installed. The arch wire will be either adjusted or replaced at various times during the treatment of the patient to maintain proper tension on the teeth as alignment of the teeth is gradually achieved.

As orthodontic treatment with braces may occur over a period of one to several years, the brackets may have to be replaced due to breakage or due to a change in the size or style of the wire used in the braces. Furthermore, as the above-noted orthodontic treatment takes place over such a long time, patients prefer aesthetically pleasing (or at least unobtrusive) brackets and arch wires to be used in the braces. Accordingly, a desire exists to provide brackets for braces that are easily replaceable and that are hidden or at least relatively difficult to see.

To achieve this goal, certain braces have been installed behind the teeth. However, such braces typically do not achieve alignment of the teeth to the same degree as braces installed on the fronts of teeth. An alternative approach is to provide clear (transparent) braces, typically of a clear mouth-piece type. However, as with braces installed behind the teeth, less alignment can typically be achieved with clear braces than can be achieved with metal or ceramic braces installed on the front sides of teeth.

Furthermore, when installing or replacing the brackets used to retain the arch wire used in braces, conventional ceramic brackets have had a tendency to break during removal. As these conventional ceramic brackets were bonded to the teeth, the portion of the ceramic bracket farthest from the tooth would crack, leaving only the portion of the ceramic bracket directly bonded to the tooth remaining. In this event, a dentist or orthodontist would typically have to grind away the portion of the bracket still stuck to the tooth. This grinding process could take up to an hour and was typically an unpleasant experience for the patient. Accordingly, a desire exists for a durable, yet more easily replaceable bracket for holding an arch wire used in alignment braces.

### SUMMARY OF THE INVENTION

One aspect of the invention provides an orthodontic bracket including a ceramic bracket portion including a receiving slot extending across at least a portion of the bracket portion and configured to receive an arch wire. This aspect also includes a metal mesh bonded to the ceramic bracket portion on a side of the ceramic bracket portion opposite the receiving slot.

Another aspect of the invention provides an orthodontic bracket including a ceramic bracket portion including a receiving slot extending across at least a portion of the bracket portion and configured to receive an arch wire. This aspect further includes a metal member bonded to the ceramic bracket portion via a first side of the metal member. The member includes a second side opposite the first side and facing away from the surface of the ceramic bracket portion on which the metal member is disposed.

Another aspect of the invention provides an orthodontic bracket including a metal bracket portion including a receiving slot extending across at least a portion of the bracket portion and that receives an arch wire. This aspect includes a tooth-colored coating disposed over at least a portion of the metal bracket.

Another aspect of the invention provides a self-legating orthodontic bracket. This aspect provides a bracket portion with a receiving slot that has first and second open ends. The receiving slot extends across at least a portion of the bracket portion and receives an arch wire. The receiving slot is bounded by at least one snap member that defines a first portion and a second portion of the receiving slot. The first portion has a width smaller than a width of the second portion.

Another aspect of the invention provides a method of installing an orthodontic brace system. The method includes providing at least one orthodontic bracket and bonding the orthodontic bracket to a tooth. The method includes inserting an arch wire into a receiving slot on the orthodontic bracket. The inserting includes pushing the arch wire against at least one snap member to deflect the snap member from an original position to a deflected position and passing the arch wire past the snap member. The method also includes allowing the snap member to move toward the original position to retain the arch wire in the receiving slot.

Another aspect of the invention provides a self-legating orthodontic bracket and alignment system. The system includes a bracket portion including a receiving slot. The receiving slot includes first and second open ends. The slot extends across at least a portion of the bracket portion and receives an arch wire. The receiving slot is bounded by at least one snap member that defines a first portion and a second portion of the receiving slot. The first portion has a width smaller than a width of the second portion. In other words, the receiving slot is narrow in one part and wide in one part. Optionally, an aligner clip couples to an outer surface of the bracket portion and slides along the bracket portion and provides a visual indication of an alignment direction of the bracket portion.

Another aspect of the invention provides a method of aligning an orthodontic bracket. The method includes providing an orthodontic bracket including a receiving slot with first and second open ends. The receiving slot extends across at least a portion of the bracket portion. The method includes coupling an alignment tool to an outer surface of at least one snap member that defines a first portion and a second portion of the receiving slot. The first portion typically has a width smaller than a width of the second portion. The method also includes placing the orthodontic bracket on a tooth. The method further includes aligning an orientation of the orthodontic bracket via a visual indication of an alignment direction of the bracket portion provided by an aligner rod.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 depicts the mouth of the patient in which a plurality of brackets according to one example of the present invention are installed;

FIG. 2 depicts a side view of one example of a bracket according to the present invention;

FIG. 3A depicts a bracket according to one example of the present invention separated into a bracket portion and metal mesh, i.e., before assembly;

FIG. 3B depicts the bracket depicted in FIG. 3A with the mesh in an installed state;

FIG. 3C depicts a variation of the bracket depicted in FIG. 3B in which a mesh is installed around a perimeter of a bottom surface of the bracket portion;

FIG. 4 depicts a side view of another example of a bracket according to the present invention, including an insert;

FIGS. 5A and 5B depict a side and perspective view of a bottom of a bracket portion including an insert (5A) and before an insert is installed (5B);

FIG. 5C depicts a side view of an alternate embodiment of a bracket according to the present invention with an insert installed;

FIG. 5D depicts another example of a bracket with an insert installed according to the present invention;

FIGS. 5E and 5F depict front and bottom perspective views of another embodiment of a bracket with an insert and position for an insert, respectively;

FIG. 6A depicts a perspective view of another example of a bracket according to the present invention;

FIG. 6B is a bottom perspective view of a bracket similar to the inventive bracket depicted in FIG. 6A;

FIG. 6C is a cross-section side view of a bracket as depicted in FIG. 6A without a mesh;

FIG. 7A is a perspective view of one example of a bracket according to the present invention with a mesh installed;

FIG. 7B is a view of the bracket depicted in FIG. 7A with a round arch wire and legating tie installed;

FIG. 8A is another example of a bracket according to the present invention arranged with a self-legating snap trough;

FIG. 8B is a detailed view of a snap trough as depicted in FIG. 8A with a polygonal arch wire installed;

FIG. 8C is a detailed view of the snap trough depicted in FIG. 8A with a round arch wire installed;

FIG. 8D is a perspective view of the bracket depicted in FIG. 8A with a round arch wire installed;

FIG. 9A is a perspective view of another embodiment of a bracket according to the present invention with a round arch wire installed;

FIG. 9B depicts a bracket as shown in FIG. 9A in the process of being connected to an aligner clip according to another example of the present invention;

FIG. 9C is a cross-section view of the bracket depicted in FIG. 9B;

FIG. 9D is a side view of one example of an inventive bracket with a round arch wire in the process of being installed;

FIG. 9E is a side view of the bracket depicted in FIG. 9D with the round arch wire in an installed state;

FIG. 9F is a side view of the bracket depicted in FIG. 9D with a polygonal arch wire installed;

FIG. 10A depicts one example of a bracket according to the present invention without a mesh installed and in which a round arch wire is about to be installed;

FIG. 10B is another example of an inventive bracket according to the present invention in which a round arch wire is about to be installed;

FIG. 10C is another example of a bracket according to the present invention, without a mesh installed and in which an arch wire is about to be installed;

FIG. 11 depicts one example of a bracket according to the present invention installed on a tooth; and

FIG. 12 depicts an arch wire partially enclosed in a sheath according to one embodiment of the present invention.

### DETAILED DESCRIPTION OF THE PREFERRED EMBODIMENTS

Referring now to the drawings, wherein like reference numerals designate identical or corresponding parts throughout the several views.

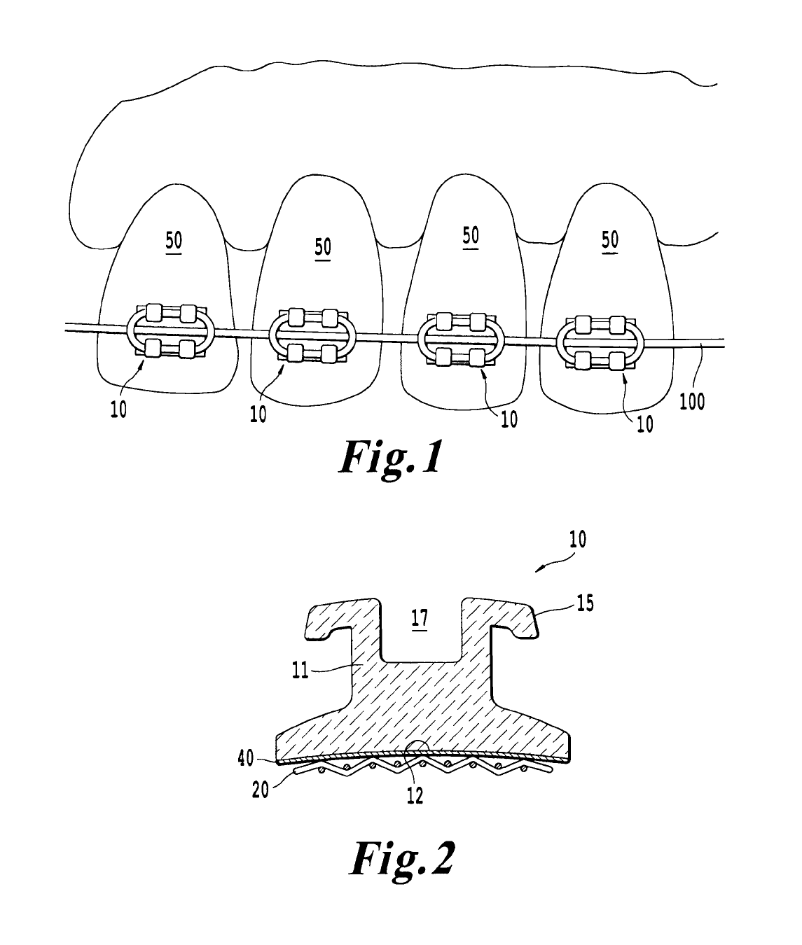

With reference to FIG. 2, a bracket 10 according to one example of the present invention is shown in side view. The bracket 10 is made of dental-grade ceramic and a metal mesh bonded at the bottom of the brace which is to be bonded to the tooth during the brace installation. With reference to FIG. 1, a plurality of the brackets 10 may be attached to a plurality of teeth in a patient's mouth. Aside from the configuration depicted in FIG. 1, various arrangements of the brackets 10 are possible.

The bracket 10 shown in FIG. 2 includes a receiving slot, in this case wire holder 17, which is configured to receive one or more types of arch wire such as round arch wire 100 or polygonal arch wire such as square arch wire 101 (see FIGS. 8B and 8C). Typically, the orthodontist will insert the arch wire 100/101 with a predetermined amount of torque or tension that pulls the tooth to which the bracket 10 is attached in a desired direction. The bracket 10 described in FIG. 2 includes a bracket portion 11, which includes a base 12 attached to a mesh 20. The mesh 20 is typically formed from stainless steel, titanium, or nickel. However, other metals may be used for the mesh 20. Noncorrosive metals are preferred for the mesh 20.

Optionally, the base 12 of the bracket portion 11 may have a metalized surface 40 disposed on its bottom. The metalized surface 40 may include one or more layers of different metals. For example, if the bracket portion 11 comprises a ceramic, then a first layer 40a directly attached to the base 12 of the bracket portion 11 will typically be a metal that adheres relatively well to ceramic. Additionally, second layer 40b may be disposed upon the first layer 40a, and a third layer (not shown) may be disposed on the second layer 40b etc. In this way, a relatively strong bond between the mesh 20 and the base 12 of the bracket portion 11 can be achieved, even if the metal used to form the mesh 20 is itself difficult to attach directly to the ceramic bracket portion 11.

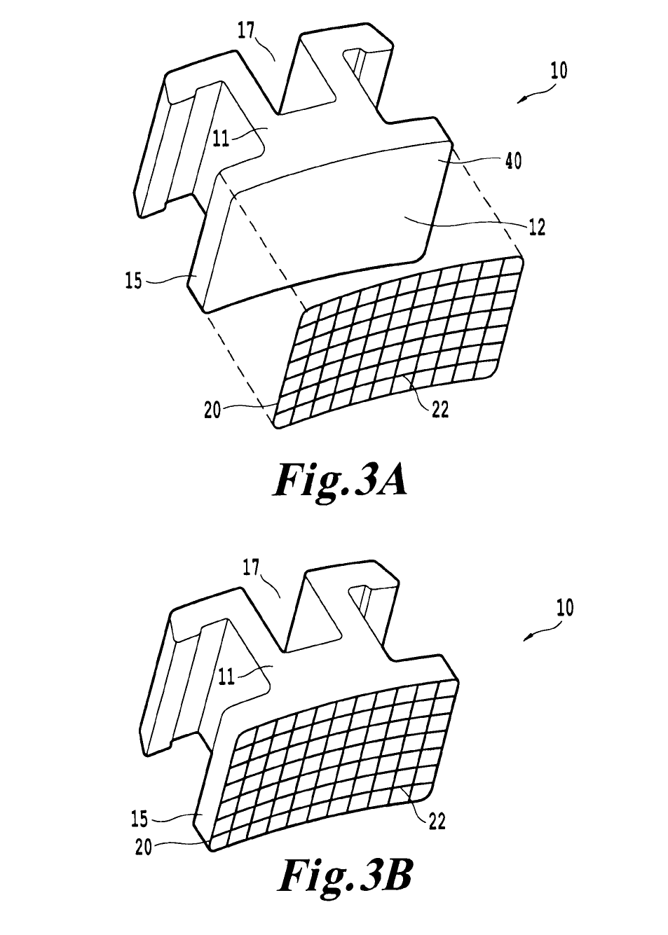

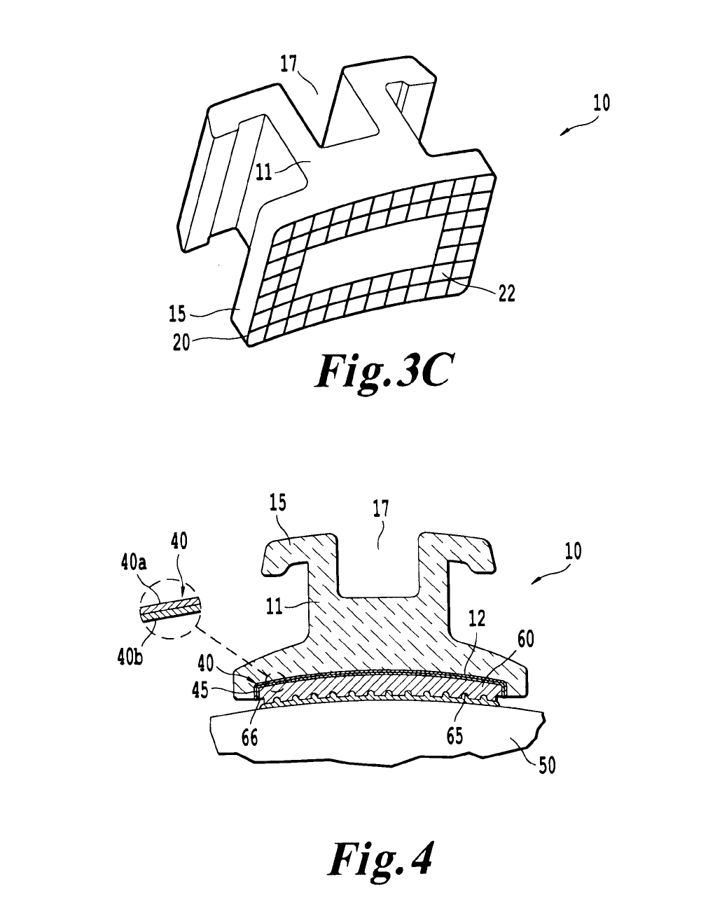

FIG. 3A shows the mesh 20 in the process of being installed onto the bottom surface of the base 12 of the bracket portion 11. As further shown in FIG. 3A, the mesh 20 typically includes openings 22. One benefit of providing a mesh with openings such as the mesh 20 shown in FIG. 3A is that the amount of surface area disposed on the bottom surface of the base 12 of the bracket portion 11 is greater than would be the case if the bottom portion of the bracket portion 11 were to remain smooth.

The relative increase in surface area on the bottom surface of the base 12 of the bracket portion 11 allows for improved adhesion of the bracket 10 to a tooth via bonding with an adhesive. Additionally, the presence of the mesh on the bottom surface of the base 12 of the bracket portion 11 acts as a reinforcement to the bracket portion 11 during installation and removal. As noted previously, ceramic brackets can be brittle and sometimes fracture during removal from a patient's tooth. Accordingly, not only does the presence of the mesh 20 on the bottom surface of the base 12 of the bracket portion 11 increase the strength of the bracket 10, the presence of the mesh 20 on the bottom of the base 12 of the bracket portion 11 improves the ability of the bracket 10 to be removed from a patient's tooth.

FIG. 3B shows the bracket 10 after the mesh 20 is installed on the bottom surface of the bracket portion 11 via the base 12. In one example, the mesh 20 is glued to the surface of the bracket portion 11 with an adhesive. Examples of adhesive used to attach the mesh 20 to the base 12 of the bracket portion 11 include 1-part epoxy, 2-part epoxy, and dental cement.

In an alternate embodiment, the mesh 20 is welded or brazed to the bottom surface of the bracket portion 11. For example, an electrical connection may be applied to the metalized surface 40, if present, and an opposite electrical connection, such as an electrical ground, may be applied to the mesh 20. Thus, at the points of contact between the metalized surface 40 and the mesh 20, increased current will cause localized heating and melting of at least one of the metalized surface and the mesh. Upon cooling of the melted material after removal of the electric current, the mesh is securely attached to the surface of the bracket portion 11.

FIG. 3C depicts an example of the mesh 20 depicted in FIG. 3B, but attached only to a periphery of the bottom surface of the bracket portion 11. Typically, the periphery of the bracket portion 11 is the most important area to attach to the tooth. As is further evident in FIGS. 2, 3A, 3B, and 3C, the bottom surface of the bracket portion 11 is typically provided with at least a slight curvature. This curvature is typically specifically adapted to different teeth in the patient's mouth. In some cases, the mesh is pre-bent before installation. In other cases, the mesh is bent as it is installed.

The mesh 20 is typically 1/1000 to 30/1000 of an inch thick and preferably 5/1000 to 20/1000 of an inch thick. The bottom surface of the bracket portion 11 is typically from 2 to 5 millimeters on a side. The mesh 20 depicted in FIGS. 3A-3C is shown in rectangular or square format. However, other shapes are available, such as circular, heart-shaped or elliptical, for example.

The optional metallization of the surface of the bracket portion 11 is typically performed via some form of vacuum deposition such as chemical vapor deposition (CVD), sputtering, or evaporation. Examples of vacuum deposition are described in THIN FILM PROCESSES, JOHN L. VOSSEN and WERNER KERN, (Academic Press 1978), the entire content of which is herein incorporated by reference. However, the metalized surface can be formed via other methods such as spraying, dipping, or plating, for example.

The metallization of the bottom surface of the bracket portion 11 is optional, and mesh may be directly attached to the bottom of the bracket portion 11 without any metallization, for example, via epoxy or cement.

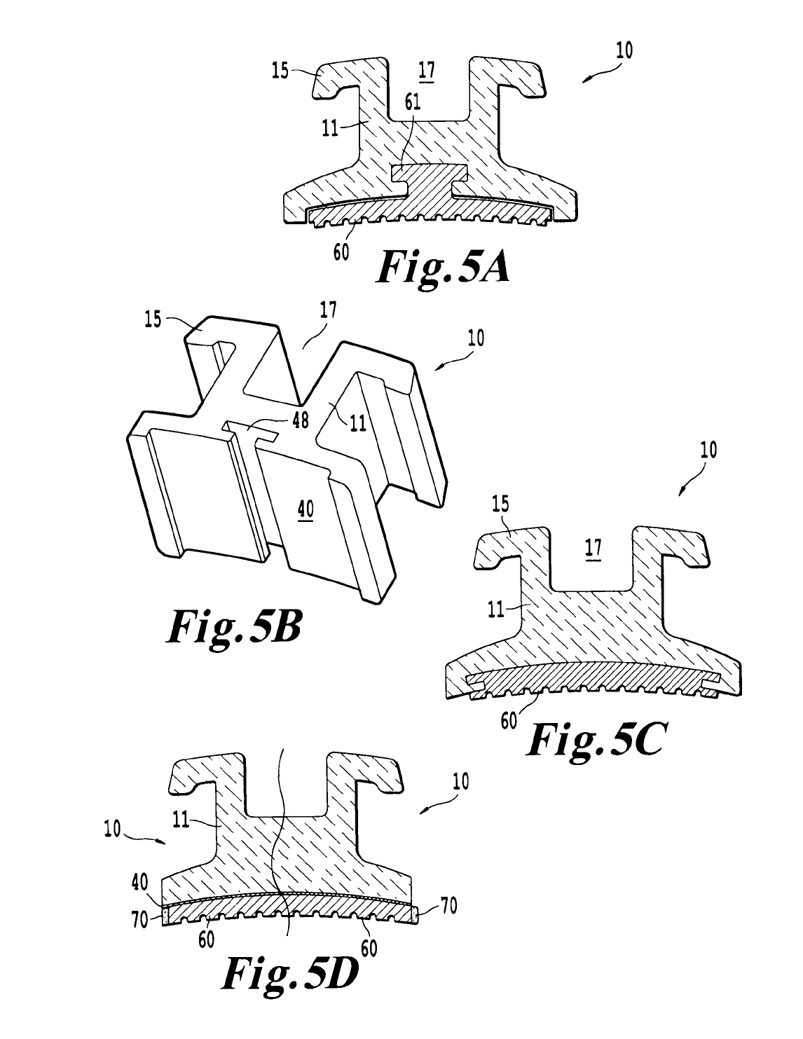

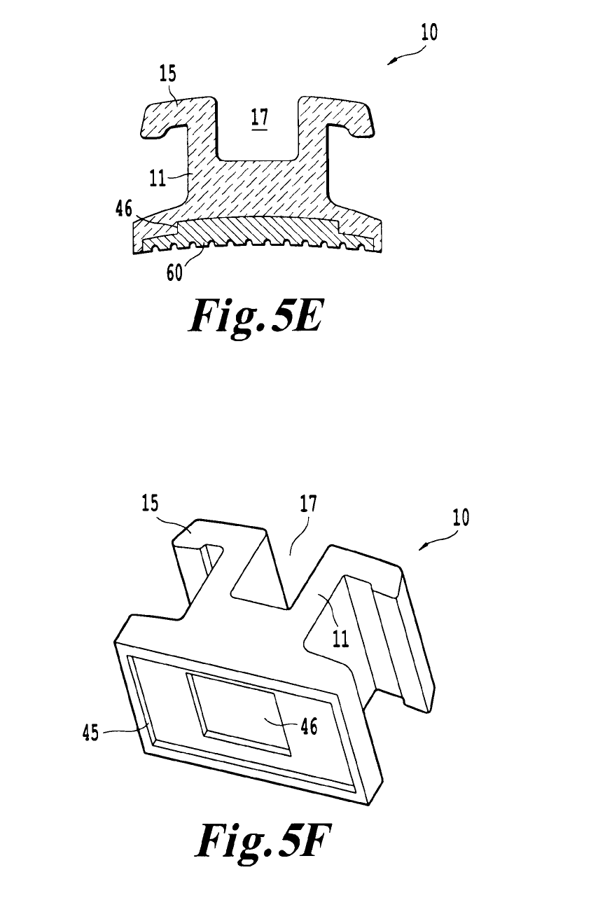

With the above-noted mesh 20, improved adhesion to the tooth and increased durability of the bracket 10 can be provided. The mesh 10 is shown in FIGS. 2-3C attached directly to a bracket portion 11 via an optional metalized surface 40. However, in the following embodiments, the mesh 20 may be optionally added on the bottom surface of an additional insert such as a metal insert which will be described as follows with respect to FIGS. 4-5F.

FIG. 4 is a side view, in cross-section, of a ceramic bracket 10 including a wire holder 17 bounded by ears 15. The bracket portion 11 of the bracket 10 abuts a member such as insert 60. The insert 60 typically comprises nickel, stainless steel, or titanium. However, other metals may be used for the insert 60. In the embodiment shown in FIG. 4, the bracket portion 11 comprises ceramic. Thus, the insert 60 disposed on the bottom surface of the bracket portion 11 can replace mesh 20. Alternatively, the insert 60 can be used in combination with the mesh 20. The mesh 20 and the insert 60 may be the same material. However, the mesh 20 may be welded or brazed to the insert 60, even if the materials are not identical. For example, if different types of stainless steel are used, it may still be possible to weld or braze the mesh 20 and insert 60 together.

If the material of the mesh 20 is not weldable to the material of the insert 60, the mesh 20 may be adhered with cement or epoxy to the insert 60.

Additionally, the base 12 of the bracket portion 11 depicted in FIG. 4 optionally includes a metalized layer 40 as discussed above with respect to FIGS. 2-3C. However, in the embodiment depicted in FIG. 4, the metalized layer 40 connects directly with the metal insert 60, which is itself formed of metal. The metals used to make the metalized layer 40 and insert 60 may be the same or different. However, typically, the best bonding occurs when the metals used for the metalized layer 40 and insert 60 are the same. Bonding between the metalized layer 40 and insert 60 can be via an adhesive, welding, or brazing, for example. Similar techniques can be used to bond the optional mesh 20 to the insert 60.

As shown in the example depicted in FIG. 4, the insert 60 typically includes pockets or indentations such as grooves 65 disposed on its bottom surface. These indentations or pockets, similar to the holes 22 in the mesh 20, increase the relative surface area of the insert 60. One benefit of the increased surface area of the insert 60 is typically a relative increase in bonding strength between the insert 60 and a tooth 50 to which the insert 60 is attached. The insert 60 can be attached to the tooth 50 via one-part or two-part epoxy, or other types of epoxy. However, other examples of bonding materials may be used such as cement.

In the embodiment shown in FIG. 4, the insert 60 includes an indent 66 disposed on its edges. The indent 66 allows for connection with a dental tool used to remove the bracket 10 from the tooth 50 upon completion of treatment or during changes in treatment. The indent 66 is depicted as having a right-angle shape, but other shapes are available, such as circular or elliptical.

In an alternate version of the insert 60 shown in FIG. 4, the insert extends to the edges of the footprint of the bracket portion 11 as shown in FIG. 5D. One benefit of this arrangement is that less of a crevice is provided between the bracket portion 11 and the tooth 50, therefore, cleanliness is typically greater with the insert 60 extended to the edge of the bracket portion 11. However, as the bracket is intended to be visually unobtrusive, it is sometimes preferred to coat the insert 60 with a coating 70 having a color similar to the color of the tooth 50 (see FIG. 5D, which depicts two different styles of insert 60). In one example, the coating 70 is from 0.001 inches to 0.030 inches thick. A preferred thickness of coating is from 0.003 to 0.010 inches thick.

FIG. 5A depicts a cross-section of another example of a bracket portion 11. As shown in FIG. 5B, the bracket portion 11 includes an insert channel 48 configured to receive a T-shaped profile of the insert 60. The T-shaped profile 61 of the insert 60 slides into the insert channel 48. Typically, the insert channel 48 imparts greater strength to the connection between the insert 60 and the bracket portion 11. If the bottom surface of the bracket portion 11 is metalized, the insert channel 48 may also be metalized. With this arrangement, a large area of welding or adhesive bonding can be provided between the optionally metalized surface 40 and the insert 60.

FIG. 5C describes an alternate embodiment of the insert 60 connected to the bracket portion 11. As shown in FIG. 5C, the bracket portion 11, on its lateral edges, becomes fairly thin. Thus, when removing the bracket portion 11 depicted in FIG. 5C, the bracket portion 11 may crack or even disintegrate. However, the bracket portion 11 will typically remain attached to the tooth via its original bonding. In this case, even if the bracket portion 11 has been destroyed, the dentist will still be able to remove the insert 60 from the tooth as this portion will now be directly exposed for access to a tool used by the orthodontist. Furthermore, the insert 60 will be relatively easy to grab, especially if the insert 60 has some form of indent 66 or other graspable profile.

FIG. 5D depicts an insert 60 that extends from approximately one edge of the bracket portion 11 to the other. In other words, FIG. 5D shows (on one side of the drawing) the insert 60 having the same footprint as the bracket portion 11 when the footprint is defined as the area of the bracket portion 11 or insert 60 closest to the tooth when the bracket 10 is in a state bonded to the tooth. Thus, as described above, most of the crevice area between the bracket portion 11 and the insert 60 is eliminated, and food is less likely to be trapped between the bracket 10 and the tooth 50. Optionally, as also shown in FIG. 5D, a coating 70 may be applied to the edges of the insert 60 in order to reduce its visibility. Typically, the coating 70 is some form of enamel, epoxy, polymer, or porcelain. However, other materials may be used. The coating 70 may protrude slightly from the bracket 10 if the insert 60 is attached so as to be flush with the vertical sides of the bracket portion 11 (when the insert 60 has the same footprint as the bracket portion 11). In other words, the insert 60 forms a bottom layer of the bracket 10 that would be exposed on lateral sides of the bracket 10 if no coating 70 were present. The coating 70 then covers the insert 60 and the combination of the coating 70 and insert 60 has a width dimension wider than the bracket portion 11. Alternatively, the insert 60 can be slightly narrower than the bracket portion 11, and the coating 70 can fill in the difference in width between the bracket portion 11 and the insert 60 so as to form a flush, or nearly flush, surface with the vertical surface of the bracket portion 11 shown in FIG. 5D. In either case, if the coating 70 breaks away during removal of the bracket 10, the insert 60 will still serve as a reinforcement, and can also be grabbed by the orthodontist, typically with a removal tool.

FIGS. 5E and 5F depict another embodiment of an insert 60. In this embodiment, a recess 45 is provided on the bottom surface of the bracket portion 11, and a second recess 46 is provided within the recess 45. This arrangement increases the amount of surface area provided for contact between the bracket portion 11 and the insert 60, and therefore, increases the relative bonding strength between these two components. The recess 46 can be provided on any of the examples using the insert 60 provided in the present disclosure. Additionally, the insert 60 may be used in combination with a recess that is deep enough to allow the ceramic bracket portion to be in direct contact with the tooth once the bracket 10 is bonded to the tooth. In other words, walls of the recess 10 will completely cover the insert 60 (except for the portion of the insert 60 bonded to the tooth) once the bracket 10 is in place on the tooth. In this case, little or no crevice will remain to retain food between the bracket 10 and the tooth. Additionally, the insert 60 will be practically invisible.

As discussed above, a mesh 20 may be optionally added to any of the above-noted arrangements. Additionally, the insert 60, instead of including grooves 65, may have another pattern, such as a waffle or diamond pattern on its bottom surface to increase its relative surface area for bonding. In another example, the insert 60 may include a dimpled pattern on its surface in order to increase surface area.

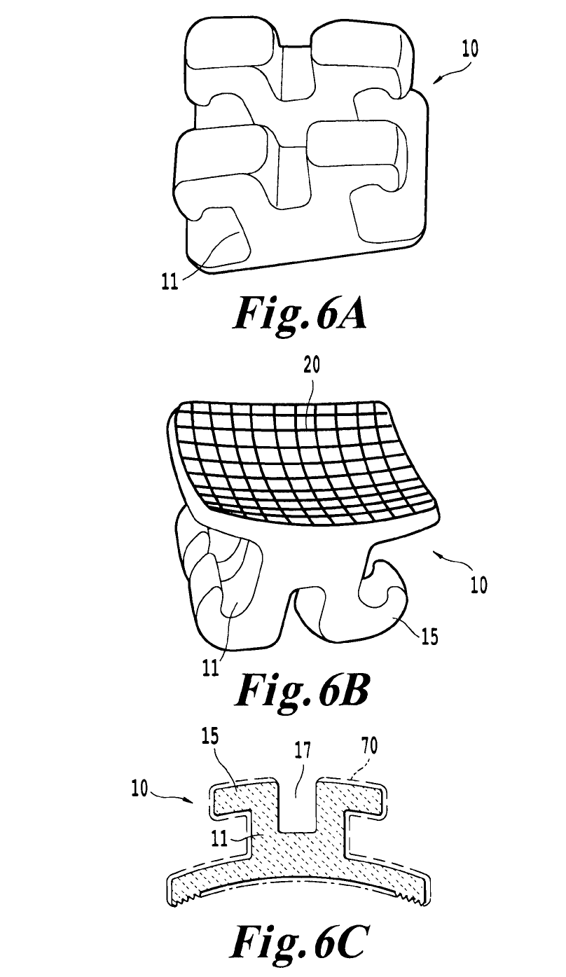

FIG. 6A depicts another embodiment of a bracket according to the present invention. In this arrangement, the bracket 10 has a core of metal and a tooth-colored coating 70 over at least a portion of its surface. FIG. 6A is a perspective view of a metal bracket with a coating according to the above-noted description. FIG. 6B is a bottom perspective view of the bracket depicted in FIG. 6A. As can be seen in FIG. 6B, the bottom surface of the bracket portion 11 includes a mesh 20. The mesh 20 can be part of the original metal or a separate attachment as is added to the previous embodiments. Furthermore, the mesh 20 is optional and may be excluded. In this case, the metal core of the bracket 10 will provide greater strength than conventional brackets, and reinforcement of the bracket 10 is not needed.

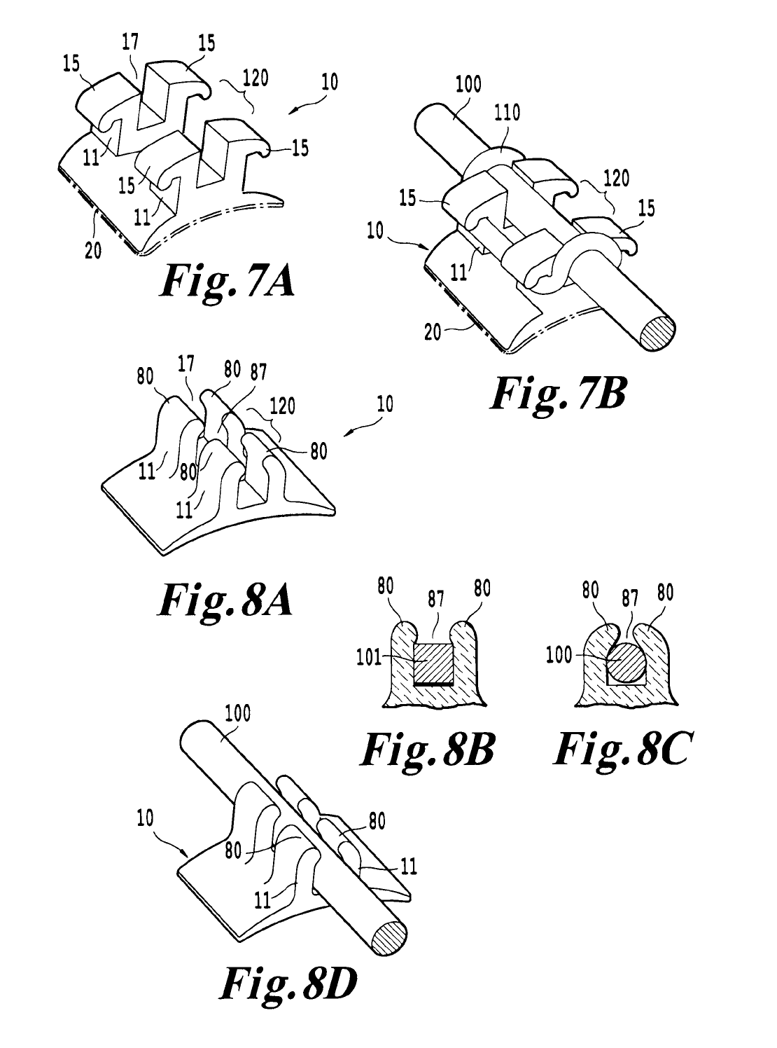

FIG. 6C depicts the tooth-colored coating 70, in cross-section, disposed on at least a portion of the bracket portion 11. In the embodiment shown in FIG. 6C, the wire holder 17 is not coated. While, this area may be optionally coated, it is preferred to leave the wire holder uncoated inasmuch as precise control over the tension provided in the arch wire 100/101 (see FIGS. 7B and 8D) is desired. Typically, the coating 70 will have some variation in its thickness. Therefore, leaving the wire holder 17 uncoated allows for greater control of the contact force between any wire inserted in the wire holder 17 and the bracket 10.

FIG. 7A depicts another example of a bracket according to the present invention. In this case, the bracket 10 is made of metal and coated with a tooth-colored coating. The bracket 10 includes two pairs of ears 15 similar to conventional uncoated metal dental brackets. As shown in FIG. 7B, a circular arch wire 100 is typically inserted into the wire holder 17, and a legating tie 110 is wrapped around the ears in order to secure the arch wire 100 within the wire holder 17 in the same manner as for conventional dental brackets. Although the arch wire 100 depicted in FIG. 7A is circular, arch wires of other cross-sectional shapes may be used, such as the polygonal arch wire 101.

In an alternate embodiment, shown in FIGS. 8A and 8D, instead of including ears 15 and a wire holder 17, the bracket portion 11 may be provided with snaps 80 forming a snap trough 87 that functions as a receiving slot configured to receive the arch wire. As shown in FIGS. 8B, 8C, and 8D, the arch wire 100/101 snaps into place in the snap trough 87. One benefit of this arrangement is that no legating tie 110 is required in order to maintain the arch wire 100/101 in position in the bracket 10. Thus, as fewer crevices are formed (due to the absence of the legating tie 110), the arrangement depicted in FIGS. 8A and 8D is typically cleaner and possibly less visibly obtrusive than the arrangement depicted in FIGS. 7A and 7B. Additionally, the arch wire 100/101 is easier to insert and remove inasmuch as no legating tie 110 must be separately added/removed. Typically, 0.002 to 0.020 inch of deflection for each of the snaps 80 is provided for insertion and removal of the arch wire 100/101. However, other amounts of deflection may be used depending on the amount of tension required in the arch wire 100/101.

As shown in comparison between FIGS. 8B and 8C, not only is circular arch wire 100 used within the snap trough 87, polygonal, e.g, square or rectangular, arch wire 101 may be used. Similarly, circular or square, or another cross-section of arch wire may be used in the wire holder 17 of the previous embodiments. In some examples of the invention, the snap trough 87 is coated with the coating 70 as is depicted in FIG. 5D and 6C. However, as noted previously, due to potential irregularities in the thickness of the coating 70, it is sometimes beneficial to leave the area of the bracket 10 directly contacting the arch wire 100/101 uncoated so that the bracket portion 11 itself may be used to hold the arch wire 100/101. Thus, the remainder of the bracket 10 will be coated, or, as discussed above, the bottom portion of the bracket 10 will be left uncoated in order to enhance bonding of the bracket to the tooth.

FIG. 7A and FIG. 8A each depict an alignment slot 120 between the pairs of ears 15 or pairs of snaps 80. The alignment slot 120 is typically used with a tool that indicates the orientation of the bracket 10 during install onto a tooth 50. It is important for an orthodontist to be able to properly align the axis of the bracket 10 with the axis of the root of the tooth so that a particular amount of angular adjustment may be made to the tooth in order to straighten it. Thus, the tool that is inserted into the alignment slot 120 assists in providing a visual indication of the angle of the bracket relative to the angle of the tooth.

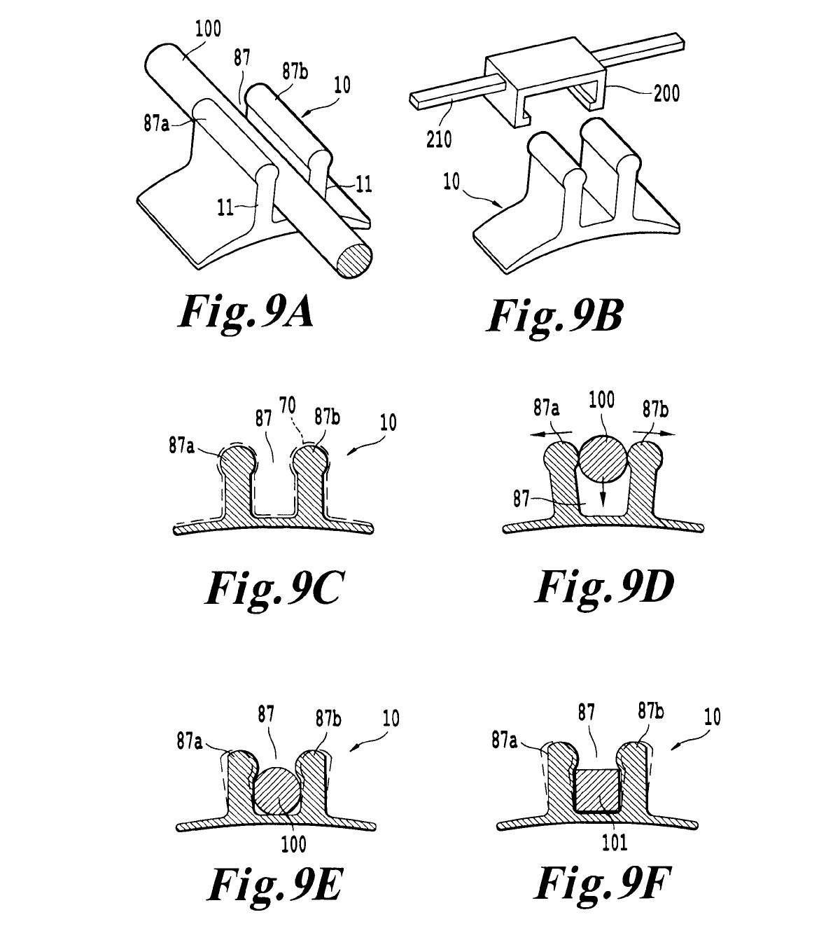

FIG. 9A describes a bracket 10 without an alignment slot 120. In this case, the snap trough 87 is formed with two long snaps 87a and 87b extending from one open end of the snap trough 87 to the other open end of the snap trough. In other words the snap trough 87 (receiving slot) does not include a standard alignment slot 120, but instead is continuous from one open end to the other. In place of an alignment tool inserted into an alignment slot 120, the bracket 10 described in FIG. 9A is configured to couple with an aligner rod 210 attached to an alignment clip 200 (see FIG. 9B). The alignment clip 200 snaps onto the long snaps 87a and 87b, and the aligner rod 210 indicates whether the bracket 10 is oriented correctly on the tooth. Upon completion of the alignment, the alinger clip 200 cam be removed from the bracket.

FIG. 9C depicts a coating 70 disposed over a portion of the snap trough 87 (on the snaps 87a and 87b). The coating 70 is optional and is usually provided when the bracket portion 11 is made from a material other than ceramic, such as metal. When provided, the coating 70 is typically tooth-colored, i.e., white, off-white, slightly yellow, or ivory.

One benefit of the arrangement depicted in FIG. 9A, wherein no alignment slot 120 is provided, is that fewer shadows are cast by the bracket 10 than are cast with either of the brackets shown in FIGS. 7A or 8A, thus improving asthetics of the dental brackets. Additionally, there are typically fewer crevices in which food material can collect. Therefore, this embodiment is generally cleaner than the embodiments using an aligner slot 120.

FIGS. 9D-9F show the process of inserting a round arch wire 100 into a snap trough 87 or inserting a polygonal arch wire 101 into a snap trough 87. As can be seen in FIG. 9D-9F, the snaps 87a and 87b typically deflect outward to accommodate insertion of the arch wire 100/101. Thus, by applying force, the orthodontist may insert and remove the arch wire 100/101 from the bracket 10 without the need of a legation tie 110.

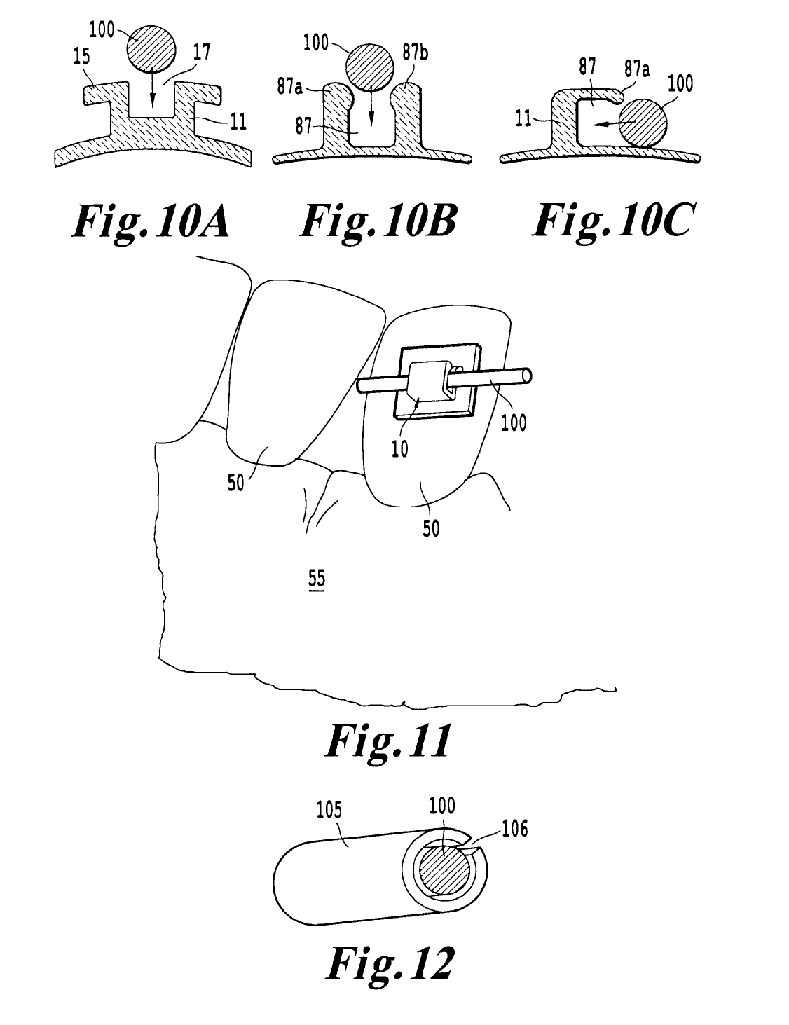

FIG. 10A shows a coated bracket portion 11 arranged to receive an arch wire and including ears 15 configured to receive a legation tie 110. No mesh or insert is shown attached to the bracket portion 11, but one may be added if desired.

FIG. 10B shows a self-legating coated bracket portion 11 including a snap trough 87 and snaps 87a and 87b.

An alternate embodiment of a self-legating bracket portion is shown in FIG. 10C in which the arch wire 100 slides into the snap trough 87 in a direction roughly parallel to a bottom surface of the bracket portion 11. One benefit of this arrangement is that even fewer shadows are cast by the bracket portion 11, and the bracket 10, once installed, is typically less visible than either of the brackets 10 depicted in FIGS. 10A and 10B.

FIG. 11 depicts a bracket 10 as shown in FIG. 10C attached to a tooth 50. While the opening of the snap trough 87 is open toward a roof of the mouth in FIG. 11, the bracket 10 may be reversed in position so that the opening of the snap trough 87 opens toward the bottom of the mouth.

In practice, the bracket 10, whether it includes an insert 60, mesh 20, or both, will be assembled prior to attachment to the tooth 5. Any welding or metallization will typically have occurred in the factory before installation on the tooth 5. The bracket 10 will then be bonded to the tooth 5 via an adhesive such as epoxy or cement. The adhesive will adhere to a surface of the tooth and of the mesh 20 or insert 60, thus holding the bracket 10 in place. If the bracket 10 comprises a metal core, bonding may be directly between the metal core and the tooth.

FIG. 12 depicts an arch wire 100 encased in a sheath 105 with an opening 106. The opening 106 allows the sheath to be placed over an arch wire 100/101. The sheath 106 will typically include an internal cross-section matching the arch wire over which it is placed, for example, circular or polygonal. The sheath 105 is typically tooth-colored, the same way as the brackets 10. Thus, the sheath-covered arch wire 100 is visually less obtrusive. In one example, the sheath is made of silicone. However, other materials may be used. The wire/sheath combination depicted in FIG. 12 may be used with any of the brackets and arch wires described herein.

Although only certain embodiments of this invention have been described in detail above, those skilled in the art will readily appreciate that many modifications are possible in the exemplary embodiments without materially departing from the novel teachings and advantages of this invention. For example, the mesh 20 may be used with or without the insert 60 in any of the configurations of the bracket portion 11 depicted in the enclosed figures. Additionally, a coating 70 may be attached to any of the bracket portions 11, inserts 60, or meshes 20 described above. Accordingly, all such modifications are intended to be included within the scope of this invention.

1. An orthodontic bracket comprising:
a ceramic bracket portion including a receiving slot that extends across at least a portion of the bracket portion and that receives an arch wire; and
a metal mesh bonded to the ceramic bracket portion on a side of the ceramic bracket portion opposite the receiving slot.

2. The orthodontic bracket according to claim 1, further comprising an adhesive layer disposed between the metal mesh and the ceramic bracket portion.

3. The orthodontic bracket according to claim 2, wherein the adhesive layer comprises epoxy.

4. The orthodontic bracket according to claim 1, further comprising a metal layer disposed between the mesh and the ceramic bracket portion.

5. The orthodontic bracket according to claim 4, wherein the mesh comprises a first metal, and the metal layer comprises a second metal different from the first material.

6. The orthodontic bracket according to claim 4, wherein the mesh comprises a same metal as the metal layer comprises.

7. The orthodontic bracket according to claim 4, wherein the mesh is bonded to the ceramic bracket portion along a curved surface.

8. The orthodontic bracket according to claim 1, wherein the bracket portion includes first and second ears extending away from a base of the bracket portion and arcing first and second directions, respectively,
wherein the receiving slot is disposed between the first and second ears, and
wherein the first and second directions are opposite to each other such that the ears extend away from the receiving slot.

9. The orthodontic bracket according to claim 8, wherein the bracket portion includes no more ears than the first and second ears.

10. The orthodontic bracket according to claim 8,
wherein the bracket portion includes third and fourth ears extending away from the base of the bracket portion and arcing in the first and second directions, respectively, and
wherein an alignment slot is disposed between the first and second ears on a first side and the third and fourth ears on a second side.

11. The orthodontic bracket according to claim 1, wherein the bracket portion includes first and second snaps extending away from a base of the bracket portion and arcing first and second directions, respectively,
wherein the receiving slot is disposed between the first and second ears, and
wherein the first and second directions are opposite to each other such that the snaps extend toward the receiving slot.

12. The orthodontic bracket according to claim 11, wherein the bracket portion includes no more snaps than the first and second snaps.

13. The orthodontic bracket according to claim 11,
wherein the bracket portion includes third and fourth ears extending away from the base of the bracket portion and arcing in the first and second directions, respectively, and
wherein an alignment slot is disposed between the first and second ears on a first side and the third and fourth ears on a second side.

14. A method of bonding an orthodontic bracket to a tooth, the method comprising:
providing a ceramic bracket portion;
bonding a metal mesh to a base of the ceramic bracket portion; and
adhering the metal mesh to a surface of a tooth.

15. The method of bonding an orthodontic bracket to a tooth according to claim 14, further comprising depositing a first metal layer on the base of the bracket portion before bonding the metal mesh to the base, such that the metal mesh is bonded to ceramic material of the ceramic bracket portion via the metal layer.

16. The method of bonding an orthodontic bracket to a tooth according to claim 15, wherein the depositing a first metal layer comprises depositing the metal layer under vacuum conditions.

17. The method of bonding an orthodontic bracket to a tooth according to claim 15, wherein the bonding a metal mesh to a base of the ceramic bracket portion comprises welding the metal mesh to the first metal layer.

18. The method of bonding an orthodontic bracket to a tooth according to claim 15, further comprising depositing a second metal layer on the first metal layer such that the first metal layer is in direct contact with the ceramic bracket portion, and the second metal layer is sandwiched between the first metal layer and the mesh.

19. An orthodontic bracket that bonds to a tooth, the orthodontic bracket comprising:
a ceramic bracket portion; and
means for increasing surface area of a base of the ceramic bracket, said means being bonded to the ceramic bracket portion.

20. An orthodontic bracket comprising:
a ceramic bracket portion including a receiving slot that extends across at least a portion of the bracket portion and that receives an arch wire; and
a metal member bonded to the ceramic bracket portion via a first side of the metal member, the member including a second side opposite the first side and facing away from the surface of the ceramic bracket portion on which the metal member is disposed.

21. The orthodontic bracket according to claim 20, wherein the member includes pockets on the second side.

22. The orthodontic bracket according to claim 21, wherein the pockets include grooves.

23. The orthodontic bracket according to claim 20, wherein the metal member is disposed at least partially within a first recess in the ceramic bracket portion such that the metal member is bounded, within the first recess, on at least two sides by the ceramic bracket portion.

24. The orthodontic bracket according to claim 23, wherein the metal member is disposed partially within a second recess such that the metal member is bounded, within the second recess, on at least three sides by the ceramic bracket portion.

25. The orthodontic bracket according to claim 20, wherein the metal member is bonded to the ceramic bracket portion via a metallic layer deposited directly on the ceramic bracket portion.

26. The orthodontic bracket according to claim 20, further comprising a mesh bonded to the second side of the metal member.

27. The orthodontic bracket according to claim 26, wherein the mesh is welded to the metal member.

28. The orthodontic bracket according to claim 21, wherein the mesh comprises a metal different from the metal member.

29. The orthodontic bracket according to claim 20, wherein the ceramic bracket includes a first recess including a profile extending from one side of the ceramic bracket into the ceramic bracket to receive the metal member.

30. The orthodontic bracket according to claim 29, wherein the profile includes a T shape.

31. The orthodontic bracket according to claim 20, wherein the metal member extends from one side of the ceramic bracket to another side of the ceramic bracket.

32. The orthodontic bracket according to claim 20, wherein the metal member has a footprint the same size as a footprint of the ceramic bracket.

33. The orthodontic bracket according to claim 20, wherein the metal member has a footprint smaller than a footprint of the ceramic bracket.

34. The orthodontic bracket according to claim 33, wherein the metal member is coated with a coating.

35. The orthodontic bracket according to claim 34, wherein the coating is a same color as the ceramic bracket.

37. The orthodontic bracket according to claim 34, wherein a footprint of the metal member in combination with the coating is a same size as a footprint of the ceramic bracket.

38. The orthodontic bracket according to claim 20, wherein the metal member includes at least one notch that assists in handling of the metal member.

39. The orthodontic bracket according to claim 20, wherein the at least one notch includes at least two notches disposed on opposite sides of the metal member.

40. An orthodontic bracket comprising:
a metal bracket portion including a receiving slot that extends across at least a portion of the bracket portion and receives an arch wire; and
a tooth-colored coating disposed over at least a portion of the metal bracket.

41. The orthodontic bracket according to claim 40, wherein the receiving slot is at least partially uncovered by the coating.

42. The orthodontic bracket according to claim 40, wherein a surface of the bracket, on a side other than a side on which the receiving slot is disposed, is at least partially uncovered by the coating.

43. The orthodontic bracket according to claim 42, wherein the surface is bonded to a mesh.

44. The orthodontic bracket according to claim 43, wherein the mesh comprises metal.

45. The orthodontic bracket according to claim 44, wherein the mesh is welded to the metal bracket.

46. The orthodontic bracket according to claim 45, wherein the mesh and metal bracket comprise a same material.

47. The orthodontic bracket according to claim 40, wherein a maximum thickness of the coating is from 0.001 inches to 0.030 inches.

48. The orthodontic bracket according to claim 47, wherein a maximum thickness of the coating is from 0.003 inches to 0.010 inches.

49. A self-legating orthodontic bracket comprising:
a bracket portion including a receiving slot, including first and second open ends, that extends across at least a portion of the bracket portion and that receives an arch wire,
the receiving slot being bounded by at least one snap member that defines a first portion and a second portion of the receiving slot, the first portion having a width smaller than a width of the second portion.

50. The self-legating orthodontic bracket of claim 49, wherein the at least one snap member includes first and second snap members, and the width is measured between the first and second snaps.

51. The self-legating orthodontic bracket of claim 49, wherein
the first and second snap members deflect from a relaxed position to widen the first portion to permit an arch wire to pass between the first and second snap members, and
the snap members move toward a relaxed position to retain the arch wire in the second portion.

52. The self-legating orthodontic bracket of claim 49, wherein the snap members each deflect approximately 0.002 to 0.020 inch to allow an arch wire to enter the second portion.

53. The self-legating orthodontic bracket of claim 49, further comprising a metal mesh disposed on a side of the bracket opposite the receiving slot.

54. The self-legating orthodontic bracket of claim 49, wherein the bracket portion comprises metal.

55. The self-legating orthodontic bracket of claim 54, further comprising a tooth-colored coating at least partially covering the orthodontic bracket.

56. The self-legating orthodontic bracket of claim 55, wherein at least a portion of the receiving slot is uncovered by the coating.

57. The self-legating orthodontic bracket of claim 55, wherein a surface of the bracket opposite the receiving slot is at least partially uncovered by the coating.

58. The self-legating orthodontic bracket of claim 55, wherein a maximum thickness of the coating is from 0.001 inches to 0.030 inches.

59. The orthodontic bracket according to claim 55, wherein a maximum thickness of the coating is from 0.003 inches to 0.006 inches.

60. The self-legating orthodontic bracket of claim 49, wherein the width is measured between the at least one snap member and a body of the bracket.

61. The self-legating orthodontic bracket of claim 49, wherein the at least one snap member extends in a direction approximately parallel to a surface of the bracket that bonds to a tooth.

62. The self-legating orthodontic bracket of claim 61, wherein, while the bracket is in a state bonded to a tooth, the at least one snap member deflects in a direction away from the tooth to receive an arch wire.

63. A method of installing an orthodontic brace system, the method comprising:
providing at least one orthodontic bracket;
bonding the orthodontic bracket to a tooth;
inserting an arch wire into a receiving slot on the orthodontic bracket, wherein the inserting includes
pushing the arch wire against at least one snap member to deflect the snap member from an original position to a deflected position,
passing the arch wire past the snap member, and
allowing the snap member to move toward the original position to retain the arch wire in the receiving slot.

64. The method according to claim 63, wherein providing the at least one orthodontic bracket includes coating a metal bracket with a tooth-colored coating.

65. The method according to claim 63, wherein inserting the arch wire includes inserting an arch wire having a circular cross-section.

66. The method according to claim 63, wherein inserting the arch wire includes inserting an arch wire having polygonal cross-section.

67. The method according to claim 63, wherein the receiving slot opens in a direction approximately parallel to a surface of the tooth to which the orthodontic bracket is bonded, and
the inserting includes moving the arch wire past the snap member in another direction approximately parallel to a surface of the tooth to which the orthodontic bracket is bonded and into the receiving slot.

68. The method according to claim 63, wherein the receiving slot opens in a direction approximately perpendicular to a surface of the tooth to which the orthodontic bracket is bonded, and
the inserting includes moving the arch wire past the snap member in another direction approximately perpendicular to a surface of the tooth to which the orthodontic bracket is bonded.

69. The method according to claim 63, further comprising at least partially enclosing the arch wire in a sheath before inserting the arch wire into the receiving slot.

70. The method according to claim 69, wherein the sheath is tooth-colored.

71. A self-legating orthodontic bracket and alignment system comprising:
a bracket portion including a receiving slot, including first and second open ends, that extends across at least a portion of the bracket portion and that receives an arch wire, the receiving slot being bounded by at least one snap member that defines a first portion and a second portion of the receiving slot, the first portion having a width smaller than a width of the second portion; and
an aligner clip that couples to an outer surface of the bracket portion, that slides along the bracket portion, and that provides a visual indication of an alignment direction of the bracket portion.

72. The self-legating orthodontic bracket and alignment system according to claim 71, wherein the aligner clip slides in a direction parallel to a direction extending from the first open end of the receiving slot to the second open end of the receiving slot.

73. The self-legating orthodontic bracket and alignment system according to claim 71, wherein the aligner clip provides a visual indication of the alignment direction of the bracket portion via an aligner rod extending from the aligner clip in a direction substantially perpendicular to the receiving slot.

74. The self-legating orthodontic bracket and alignment system according to claim 71, wherein the at least one snap member includes first and second snap members, and the width is measured between the first and second snap members.

75. The self-legating orthodontic bracket and alignment system according to claim 74, wherein
the first and second snap members deflect from a relaxed position to widen the first portion to permit an arch wire to pass between the first and second snap members, and
the snap members move toward a relaxed position to retain the arch wire in the second portion.

76. The self-legating orthodontic bracket and alignment system according to claim 71, further comprising a metal mesh disposed on a side of the bracket opposite the receiving slot.

77. The self-legating orthodontic bracket and alignment system according to claim 71, wherein the bracket portion comprises metal.

78. The self-legating orthodontic bracket and alignment system according to claim 77, further comprising a tooth-colored coating at least partially covering the orthodontic bracket.

79. The self-legating orthodontic bracket and alignment system according to claim 71, wherein the aligner clip is removable from the orthodontic bracket.

80. The self-legating orthodontic bracket and alignment system according to claim 71, wherein the at least one snap member continuously extends from the first open end to the second open end of the receiving slot.

81. The self-legating orthodontic bracket and alignment system according to claim 80, wherein the at least one snap member includes two snap members that continuously extend from the first open end of the receiving slot to the second open end of the receiving slot.

82. The self-legating orthodontic bracket and alignment system according to claim 81, wherein the aligner clip slides along both of the snap members from the first open end of the receiving slot to the second open end of the receiving slot.

83. A method of aligning an orthodontic bracket, the method comprising:
providing a orthodontic bracket including a receiving slot including first and second open ends and extending across at least a portion of the bracket portion;
coupling an alignment tool to an outer surface of at least one snap member that defines a first portion and a second portion of the receiving slot, the first portion having a width smaller than a width of the second portion;
placing the orthodontic bracket on a tooth; and
aligning an orientation of the orthodontic bracket via a visual indication of an alignment direction of the bracket portion provided by an aligner rod.
